(19) United States
(12) Patent Application Publication
(10) Pub. No.: US 2017/0319004 A1
(43) Pub. Date: Nov. 9, 2017

(54) METHOD, DEVICE AND APPARATUS FOR PREPARING A BEVERAGE WITH A LIQUID IMMERSIBLE BAG WITH A DESIRED STEEP TIME

(71) Applicant: Meister Cook, LLC, Fort Wayne, IN (US)

(72) Inventor: Erik MAGNER, Fort Wayne, IN (US)

(21) Appl. No.: 15/130,797

(22) Filed: May 3, 2016

(51) Int. Cl. A47J 31/52; B65D 85/812; A47J 31/06

(52) U.S. Cl. CPC A47J 31/52; A47J 31/0626; B65D 85/812

(57) ABSTRACT

The present invention relates to a method, device and apparatus for preparing a beverage with a liquid immersible bag with a desired steep time. The measurement and indication of the steep time of a beverage packaged in a disposable immersible bag is accomplished with the use of chromatography paper and color indicators. The proper combination of type, thickness, size and shape of chromatography paper used allows for the pre-setting of different desired steep times. Chromatography paper becomes translucent when wet and attached colors become visible to indicate the progress and the completion of the desired steep time.

### BACKGROUND OF THE INVENTION

### Field of the Invention

This invention relates to a device, method and apparatus for the preparation of a beverage and more particularly to a device, method and apparatus for preparing a beverage with a liquid immersible bag with a desired steep time.

### Description of the Related Art

Consumers of tea enjoy the various aspects of tea, including the taste, the sensing aroma, and the visual aspect of viewing tea ingredients and as well as the touch and feel of tea leaves and other components. Combining these aspects with the desired steep time in a disposable teabag for use in a disposable beverage cup and lid is a challenge for many restaurant chains and the background of this invention.

Many consumers enjoy tea that has steeped to their desired steep time which is the time the tea has spent in water. Typical desired steep times are based on the type of tea, such as:

| | | |
|---|---|---|
| Black Tea | 2-3 | minutes |
| Green Tea | 1 | minutes |
| Herbal Tea | 4-5 | minutes |
| Oolong Tea | 3 | minutes |
| White Tea | 30 | seconds |
| Mate Tea | 5-6 | minutes |
| Rooibos Tea | 5-6 | minutes |
| Chai Tea | 5-10 | minutes |
| Darjeeling Tea | 3-4 | minutes |

In addition, consumers may prefer variations from typical steep times, such as a lighter or a stronger tea taste that can be achieved with a shorter or longer desired steep time. Tea with a shorter than typical steep time is considered stimulating. Tea with a longer than typical steep time is considered soothing.

Consumers that want to consume tea steeped at a desired steep time may use a stopwatch or other timing devices to measure and set the time the tea was placed in water. However, this is often inconvenient, and consumers miss the stop time when conducting other activities, such as driving a car. In most cases, the consumer will leave the teabag too long in the water, resulting in tea with undesirable, often bitter taste. It is therefore important to provide a steep time indicator that is affixed to the teabag and easily observable by the consumer without the use of any other external methods.

Another aspect of providing a teabag with attached steep timer is the fact that the consumer can decide when to add the teabag with the steep timer to the water. In many quick service restaurants or in coffee/tea shops the consumer receives the cup with water with the teabag already inserted, thus providing the consumer with no control over the desired steep time. The consumer does not know how long the teabag has already been in the water. Providing a teabag with an attached steep timer resolves this problem by indicating the steep time to the consumer and allowing the customer to start steeping the tea.

Another important aspect when providing tea in a teabag with a steep timer is cost. In many segments of the food service industry as well as the retail market, tea competes with coffee products and premium tea competes with premium coffee offerings. To maintain price competiveness among coffee and tea beverages, it is therefore important to provide a cost efficient teabag with a disposable steep timer that functions without the use of external power sources, i.e. batteries that would increase cost and would limit is marketability.

As mentioned earlier, one of the components of enjoying tea is the visual aspect of viewing tea leaves and other tea components. Commonly, teabags are made from paper as the base material for the bag. Paper teabags are not transparent, but typically provide a finer filter membrane performance, allowing the use of fine grinded tea components and tea powder, which are considered inferior. These inferior tea components and tea powder often leach into the water or leave non-desirable residues inside the teacup. Premiums tea suppliers use a coarser and rough cut of tea components, allowing the use of nylon, silk and similar premium teabag materials. Thus, it is preferable to use nylon, silk and other similar materials when providing premium tea in a teabag with a steep timer. To provide a nylon or silk made teabag and manufacturer such teabags in large quantities and reasonable cost, advanced teabag filling and packaging machine are required, such as the Zenobia, manufactured by Teepack Spezialmaschinen GmbH & Co. Kg in Meerbusch, Germany.

Another facet when providing tea and other hot beverages is safety. Many restaurant customers that are ordering hot tea are handed a cup of hot water, a lid and a simple teabag with a string attached. Often the lid is already installed on top of the cup when given to the customer, requiring the customer to remove the lid in order to place a simple teabag on string into hot, warm or cold water. Especially with hot water, this could create an unsafe situation that may cause spillage of hot water and could potentially harm, i.e. burn, the customer. Once a simple teabag is placed into the cup with the hot water, some customers may attempt to re-install the lid or may leave the cup open to remove the teabag later. Either choice is unsafe, because closing the lid with the simple teabag with the string hanging out may not create a proper seal and could cause spilling, again a potential harmful situation for the customer, and leaving the lid off the cup during the tea steep time, creates an even larger danger for spilling and burning with hot water. A safer way is to insert the teabag through a lid of a disposable cup without the need of removing the lid. It is therefore important to provide a teabag made from material and structural design with sufficient structural stability to allow such insertion through a lid of a disposable cup.

Adding a teabag made from commonly used materials such tea filter paper, nylon, silk and other through an opening of a lid of a disposable cup is posing a challenge. Without sufficient structural stability, consumers may have difficulties to insert the teabag through the lid opening of the disposable cup without the use of other tools or touching the teabag itself. Some tea suppliers have introduced more rigid structures, such as sturdy capsules. However, the use of such rigid materials relinquishes the consumers of touching and feeling the tea components through the teabag material, an important aspect for many tea consumers. Thus, it is important to provide structural stability of the teabag for insertion through the lid, but with sufficient material softness and elasticity to enhance the tea consuming experience. This can be accomplished by folding, double-folding or multiple folding of the sides of teabags and introducing crease lines that will add structural stability in soft and ductile materials, such as paper filter, nylon, silk and similar materials. In addition, the use of glue and heat treatments, such as material welding and ultrasound sealing of bags to the sides, top and bottom of teabags adds structural stability.

Another aspect of structural stability of the teabag and its material is the collapse during the steeping period. Commonly used paper tea bags are known to collapse under their weight when inserted into water and soaked. The collapse prevents tea leaves from unrolling and releasing their full flavor and aroma. Instead of paper material, many tea suppliers have introduced teabags made from nylon, silk and other similar materials to limit or prevent the collapse of the teabag. Especially for premium tea, teabag collapse needs to be prevented to allow the unfolding of tea leaves.

A further important aspect is that some consumers of tea want to extract remaining water and flavors from the tea leaves before completely disposing the teabag. Without one's fingers, a spoon or other tools this is difficult to accomplish. Thus, it is important to provide an in the teabag integrated means allowing for squeezing the teabag at the end of the steeping process.

There are various other applications and patents intending to improve the consumer experience of consuming tea and other beverage when using disposable means of ingredient bags, such as a teabag. A timer based on paper with capillary action to measure the steep time of tea is disclosed in the German Gebrauchsmuster DE20119561.5. Another known steep timer is disclosed in the TEMEA product prototypes by Janja Maidl Industrial Design. This product shows a steep timer for tea that is immersed into the water simultaneously with the tea bag.

U.S. Pat. Appl. No. US2009/0041903A1 describes a teabag connected to a teabag string that carries with indicators. For activation the teabag string needs to be placed in water, which causes timer inaccuracy since for deeper cups more string would be inserted into hot water. Tests have shown that commonly used teabag string made from cotton are too slow to function effectively as steep time indicators for tea.

All the above described aspects of enjoying and consuming premium tea show that it is therefore important to provide a simple and inexpensive time indicator for indicating various stages if steep times, in combination with label flaps that can be used for squeezing remaining fluids and a disposable teabag which material and form allows for sufficient stability for through lid insertion, but still allowing consumers to view, touch and feel the individual components of tea located in the teabag.

### SUMMARY

Embodiments of the inventive liquid immersible bag with steep timer apparatus comprise of a bag, a fluid transport device, a steep timer engine and an indicator label. The bag is inserted into liquid, with the liquid travelling along the fluid transport device through its capillary action, and activating the steep timer engine. The steep timer engine is located at the indicator label, allowing the consumer to observe the desired steep time of the liquid, such as tea and other beverages.

In summary, all the above described aspects of enjoying and consuming premium tea are found in this presented apparatus. The inventive teabag with steep timer apparatus carries a simple and inexpensive time indicator for indicating various stages of steep times. It is made with a disposable teabag, which material and form allows for sufficient stability for insertion through a lid of a disposable cup, allowing consumers to view, touch and feel the individual components of tea in the teabag. Its label flaps insure a secure and a near constant insertion height from the water level in the cup. The label flaps can also be used for squeezing remaining fluids before disposing the teabag.

After inserting the bag into liquid, the consumers can observe the steep time indicator label. Based on the indication on the indicator label, the consumer may remove the bag at the desired steep time.

One aspect of the invention is to provide an apparatus that will allow measuring and indicating the steep time of a content inserted into liquid that is located in a bag made from nylon, silk of similar materials, without relying on the wicking effect of the bag itself, such as a bag made from paper material.

### BRIEF DESCRIPTION OF THE DRAWINGS

This brief description of the several view of the drawings and the detailed description of embodiments of the invention describe the bag as teabag and the liquid as water to ease the explanation of the invention and its embodiments. However, the invention will also find its use for beverages other than tea, such as coffee or medical ingredients. Instead of water, other liquids can used within the embodiments of the invention.

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a first embodiment of the present invention of a teabag with steep timer apparatus inserted into a disposable cup with lid.

FIG. 2 is a cross sectional view of FIG. 1 taken along view lines 2-2.

FIG. 3 is a cross sectional view of FIG. 1 similar to FIG. 2 but without a disposable lid.

FIG. 4 is a perspective view of the present invention of a teabag with intermittent steep time indicators.

FIG. 5 is a perspective view of the present invention of a teabag with continuous steep time indicator.

FIG. 6 is a perspective view of the present invention of a teabag with an ornamental steep time indicator.

FIG. 7 is a perspective view of a label for a continuous steep time indicator.

FIG. 8 is a perspective view of a label for intermittent steep time indicators.

FIG. 9 is a perspective view of a label with an attached rectangular shaped steep timer segment.

FIG. 10 is a perspective view of a label with an attached trapezoid shaped steep timer segment.

FIG. 11 is a perspective view of a label with an attached steep timer with pathways to intermittent steep time indicators.

FIG. 12 is a perspective view of a label with an attached rectangular shaped steep timer segment with foreign elements, fold lines and fold marks.

FIG. 13 is a perspective view of a label with an attached rectangular shaped steep timer segment and a color segment for a continuous steep time indicator.

FIG. 14 is a perspective view of a label with an attached rectangular shaped steep timer segment and color segments for intermittent steep time indicators.

FIG. 15 is a perspective view of a label with an attached rectangular shaped steep timer and fluent color marker for intermittent steep time indicators.

FIG. 16 is a perspective view of an unfolded teabag with intermittent steep time indicators as shown in FIG. 4.

FIG. 17 is a perspective view of a teabag with an outside attached fluid transport strip.

FIG. 18 is a perspective view of a teabag with a tea powder infused fluid transport strip.

FIG. 19 is a side view, in cross section, taken on section lines 19-19 of FIG. 18.

FIG. 20 is a perspective exploded view of a teabag with detached and unfolded label with an attached rectangular shaped steep timer segment and color segment for a continuous steep time indicator and showing the internal fluid movements.

FIG. 21 is a perspective exploded view of a teabag with detached and unfolded label with an attached rectangular shaped steep timer and color segment for intermittent steep time indicators and showing the internal fluid movements.

FIG. 22 is a perspective exploded view of a teabag with detached and unfolded label with an attached rectangular shaped steep timer segment and an adjacent located fluid color marker for an intermittent steep time indicator and showing the internal fluid movements.

FIG. 23 is a perspective view of a teabag with in the teabag material imbedded fluid transport device.

FIG. 24 is a perspective view of the present invention of a teabag with steep timer apparatus and shortened front flap inserted into a disposable cup with lid.

FIG. 25 is a perspective view of the present invention of a teabag with steep timer apparatus and removed front flap inserted into a disposable cup with lid.

FIG. 26 is a perspective view of the present invention of a teabag with an upright arranged steep timer apparatus embedded in the apparatus handle and with two shortened label flaps inserted into a disposable cup with lid.

FIG. 27 is a perspective view of the present invention of a teabag with detached and unfolded label with an upright arranged steep timer apparatus embedded in the apparatus handle and intermittent steep time indicators.

FIG. 28 is a perspective exploded view of the present invention of a teabag with detached and unfolded label with an upright arranged steep timer apparatus embedded in the apparatus handle and intermittent steep time indicators and showing the internal fluid movements.

FIG. 29 is a perspective exploded view of the present invention of a teabag with detached and unfolded label with an upright arranged steep timer apparatus embedded in the apparatus handle with an adjacent located fluid color marker for intermittent steep time indicators and showing the internal fluid movements.

FIG. 30 is an enlarged view of dotted rectangular section A of FIG. 29.

FIG. 31 is a perspective view of the present invention of a teabag with steep timer embedded in the apparatus handle and with two arched label flaps inserted into a disposable cup with lid.

FIG. 32 is a perspective view of the present invention of a teabag with continuous steep timer apparatus and a detached transport fluid strip.

FIG. 33 is a perspective view of an unfolded teabag with continuous steep timer apparatus and a detached transport fluid strip as shown in FIG. 32.

FIG. 34 is a perspective view of a teabag with side stiffeners and bottom stiffener.

FIG. 35 is a perspective exploded view of an unfolded label made with two integrated materials with an attached trapezoid shaped steep timer segment.

FIG. 36 is a side view, in cross section, taken on section lines 36-36 of FIG. 35.

FIG. 37 is a perspective exploded view of a teabag with detached and unfolded label made with two integrated materials with an attached trapezoid shaped steep timer segment for an intermittent steep timer indicator and showing the internal fluid movements.

Corresponding reference characters indicate corresponding parts throughout several views. Although the drawings represent embodiments of the present invention, the drawings are not necessarily to scale and certain features may be exaggerated in order to better illustrate and explain the present invention. The exemplifications set out herein illustrate embodiments of the invention, in several forms, and such exemplifications are not to be construed as limiting the scope of the invention in any manner.

### DESCRIPTION OF EMBODIMENTS OF THE PRESENT INVENTION

Various embodiments of an apparatus described here measure and indicate the steep time of tea packaged in a disposable teabag. In doing so, it allows a consumer to retain the disposable teabag in the water until the desired steep time has been achieved. This apparatus is also useable for beverages or ingredients other than tea where a certain steep time is desired. The apparatus allows the measurement and indication of a steep time for premium tea that is packaged in premium teabags, such as made from silk, nylon, and other similar material. These premium teabag materials allow the consumer to view and feel the tea ingredients when touching these. Most premium teabag materials are made from materials, such as nylon and silk, with none and nearly no capillary fluid transport characteristics and no wicking effect. The apparatus described here contains a fluid transport device, with a porous matrix, that allows the travelling of water or other fluid up to the label, then across the steep timer that then activates the steep timer indicators. Once the water or other fluids travel up the steep timer, that material of the steep timer, such as chromatography paper or simple filter paper becomes translucent. Any colors, for example food coloring power placed behind the backside of the steep timer, become visible and provide an indicator for the achieved steep time. The inventive apparatus here allows for steep time indications for tea and other beverages, even if a premium teabag is used from materials with to capillary transport or wicking effect.

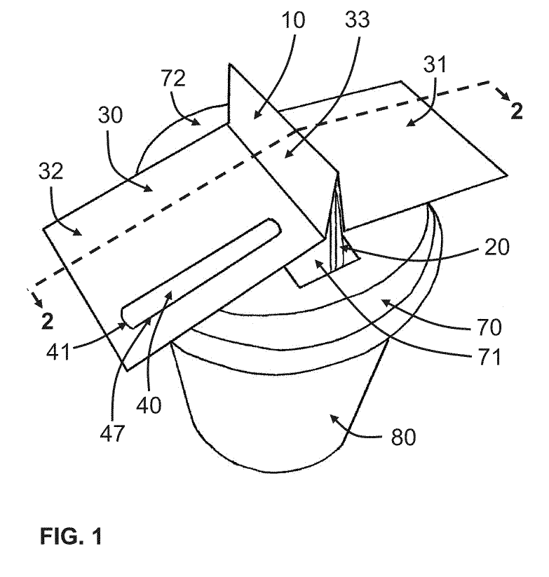

FIG. 1 shows the teabag with steep timer apparatus 10 consisting of label 30 and attached teabag 20. Teabag 20 is inserted in disposable beverage cup 80 through lid opening 71 of lid surface 72 of disposable lid 70. Label 30 consists of front label flap 31, steep timer label flap 32, and label handle 33. Steep timer label flap 32 is provided with continuous steep timer indicator 47 with elongated cutout 41 of steep timer label flap 32 through which steep timer 40 is visible.

The material of the label 30 is may be made from paper or paper cardboard with a paper bonding to provide some water resistance so that label 30 is not soaked wet when fluid travels along steep time 40. In other embodiments, label 30 is made from plastic or other inexpensive materials. Each component of label 30, including front label flap 31, steep timer label flap 32, and label handle 33 may be configured in any shape, with rectangular shapes being shown in the exemplary embodiments.

When providing an expensive means of measuring the steep time of tea, the consistency and useful accurateness of steep timer 40 should be maintained. Tests have shown that the speed of a fluid traveling along exemplary materials for steep timer 40, such as chromatography paper or simple filter paper or an equivalent material as a wicking media, is within less than +/−10% across strips of the same paper with same dimension, thickness and material. Thus, embodiments of steep timer 40 of apparatus 10 do not provide a time measurement accurate to the second, but the +/−10% accuracy range functions sufficiently and useful as a steep time indicator.

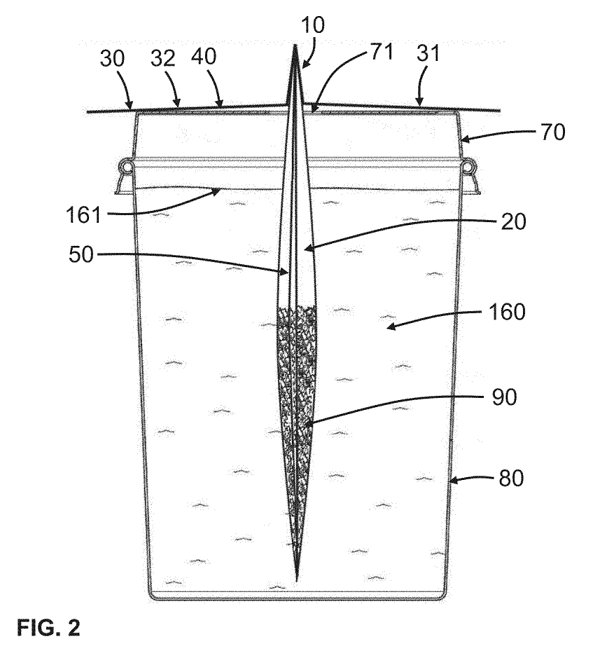

FIG. 2 illustrates a side view, in cross section, of FIG. 1. To activate steep timer 40 of the apparatus 10, teabag 20 filled with tea leaves 90 needs to be inserted through lid opening 71 of lid 70 of disposable cup 80 into water 160 or other fluid. The teabag is associated with capillary fluid transport strip 50 permitting water 160 or other fluid in disposable cup 80 travelling upwards through capillary action to steep timer 40 attached to label 30. Tests have shown that water travels upwards the first ½″ to 1″ above water line 161 in only a few seconds and that the speed of the fluid slows once it enters steep timer 40 attached to label 30. Assuming that disposable cups of water presented to consumers are filled at approximate the same level 161, and that front label flap 31 and steep timer label flap 32 of the teabag with steep timer apparatus 10 secures and helps to insert teabag 20 through lid opening 71 of lid 70 at approximately the same determined height, supports the useful accurateness as a steep time indicator.

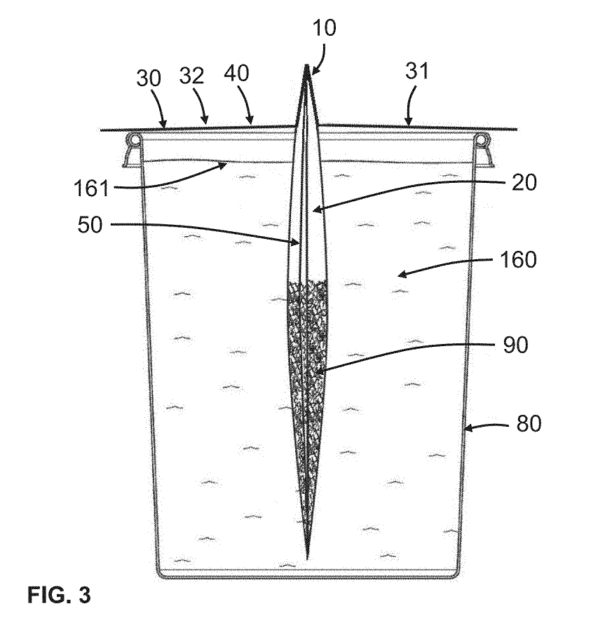

FIG. 3 shows the function of the teabag with steep timer apparatus 10 without the use of a disposable lid. Even without the lid, front label flap 31 and steep timer label flap 32 are made with thicker paper, cardboard or other materials to provide sufficient stability to maintain the desired height above water line 161. Test have shown that even without the lid, the steep timer indicator still provides useful steep time accurateness.

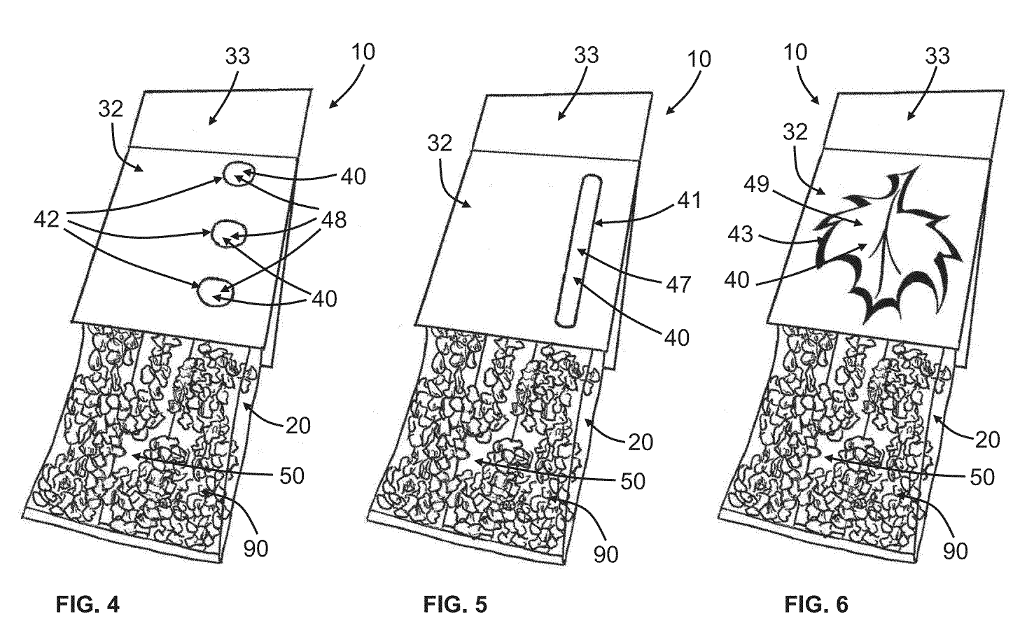

FIGS. 4 through 6 illustrate three embodiments which are variations of the teabag with steep timer apparatus 10. FIG. 4 shows the teabag with steep timer apparatus 10 with label 30 and steep timer label flap 32 with individual steep time indicators 48 with three individual cutouts 42 through which steep timer 40 is visible. Teabag 20 is filled with tea leaves 90 and contains fluid transport device 50. In another embodiment, steep timer label 32 with individual steep time indicators 48 is made with only one or two individual cutouts 42. In a further embodiment, steep timer label flap 32 with individual steep time indicators 48 is made with more than three individual cutouts 42. FIG. 4 illustrates three cutouts 42 arranged in line. In another embodiment, numerous cutouts 42 are placed in random order for individual steep time indicators 48 of steep time label flap 32. Individual steep time indicators 48 allow the consumer to observe individual steep times.

FIG. 5 shows the teabag with steep timer apparatus 10 with label 30, label handle 33 and steep timer label flap 32 with continuous steep timer indicator 47 with elongated cutout 41 of steep timer label flap 32 through which steep timer 40 is visible. Continuous steep timer indicator 47 allow the consumer to observe the continuous steep time of the teabag in water or other fluids.

FIG. 6 shows the teabag with steep timer apparatus 10 with label 30, label handle 33 and steep timer label flap 32 with ornamental steep time indicator 49 with ornamental cutout 43 of steep timer label flap 32 through which steep timer 40 is visible. The design of the ornamental steep time indicator 49 is for illustration purposes only. It is understood that an infinite variety of designs, label cutouts, and functions of the steep timer can be accomplished with an ornamental label and steep timer design.

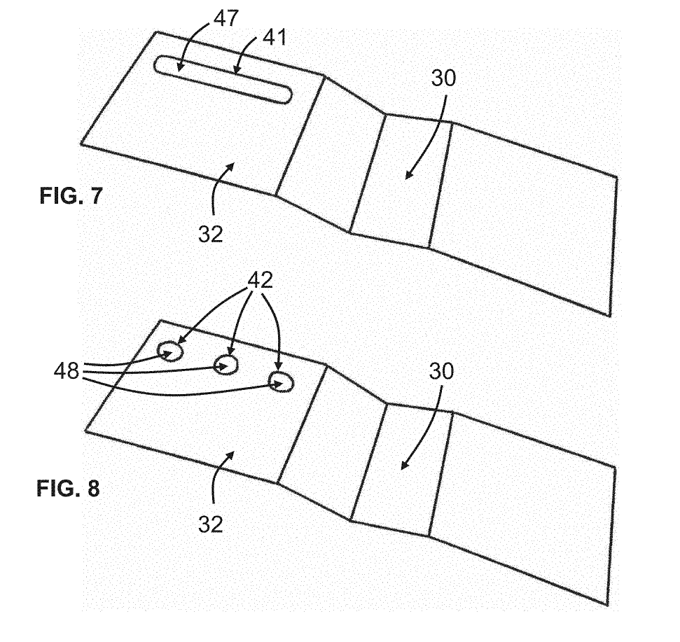

FIG. 7 shows unfolded label 30 and steep timer label flap 32 with continuous steep timer indicator 47 with elongated cutout 41 of steep timer label flap 32. FIG. 8 illustrates label 30 and steep timer label flap 32 with individual steep time indicators 48 with three individual cutouts 42.

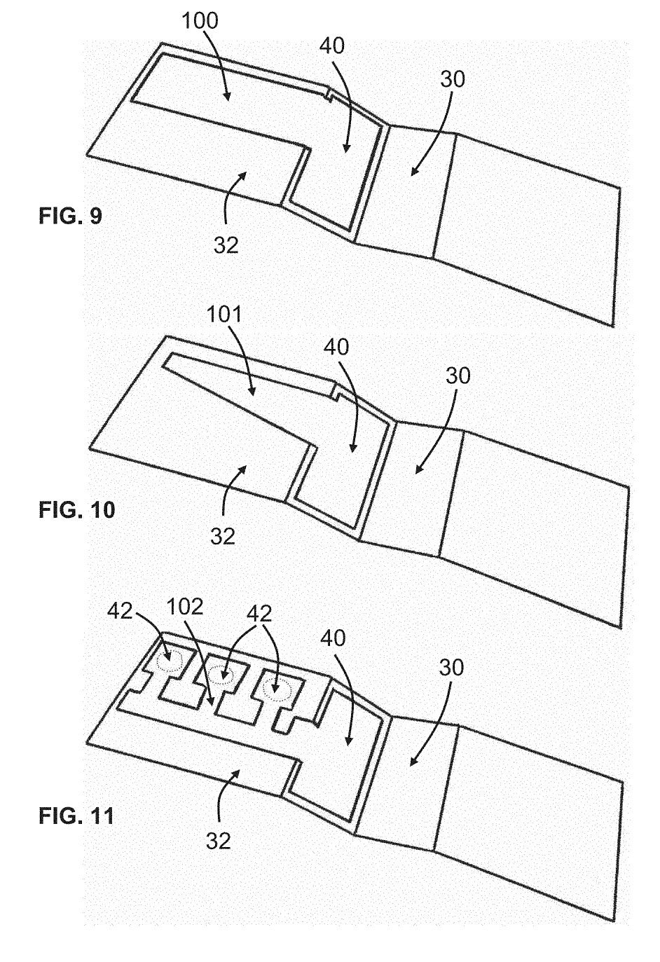

FIGS. 9 through 11 demonstrate three variations of steep timer 40 attached to steep timer label flap 32 of label 30. The combination of: a. type of capillary material, such as the type chromatography paper or filter paper, b. the thickness of the material, and c. the shape of steep timer 40 allows for the pre-setting of the desired speed of the fluid travelling via the steep timer and activating individual, continuous or ornamental steep time indicators. Thus, the steep time indicators for different tea and other beverages that have different desired steep times may be adjusted accordingly with various embodiments of the apparatus according to the present invention.

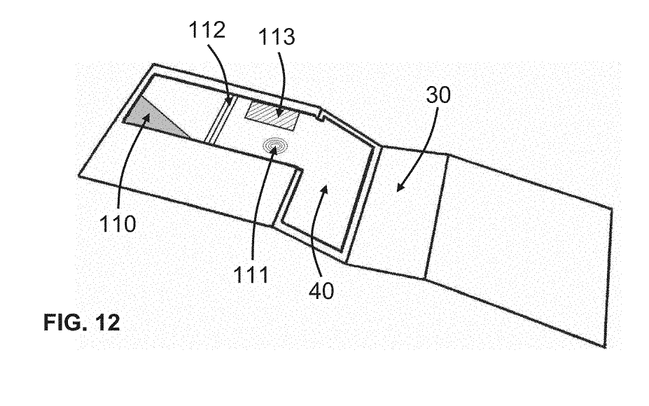

FIG. 9 shows steep timer 40 with rectangular steep timer segment 100. FIG. 10 shows steep timer 40 with trapezoid shaped steep timer segment 101. FIG. 11 shows steep timer 40 with pathway or labyrinth shaped steep timer segment 102 that guides fluid travelling along the steep timer to individual steep timer cutouts 42 located under steep timer 40. FIGS. 9 through 11 only illustrate samples of a plurality of shapes and dimensions possible for design of steep timer 40.

Tests have shown that fluid travels faster in steep timer 40 having thicker rather than thinner chromatography paper. Fluid also travel faster in steep timer 40 having a narrower or narrowing shape segment, as shown in FIG. 10, than rectangular shape segment, as shown in FIG. 9. Different widths and shapes of pathway shaped steep timer segments 102, as shown in FIG. 11, allow for different fluid travel speeds and therefor may provide to different times that individual steep timer indicators are desired to be activated.

FIG. 12 illustrates another embodiment of label 30 with steep timer 40 with foreign elements, such as glue 110, and stickers 111 or similar components, such as tape. FIG. 10 also illustrates fold lines 112, and areas of fold marks 113 or other similar paper and material impregnations. Tests have shown that glue 110 significantly hinders or even stops fluid traveling in steep timer 40. Stickers 111 hinder the speed of travel of the fluid traveling in steep timer 40. Deep fold lines 112 also hinder the fluid travel, whereas areas of fold marks 113 function as fluid accelerator if the fold lines are laced in close proximity, allowing fluid molecules to leap the fold valleys, increasing the wicking effect.

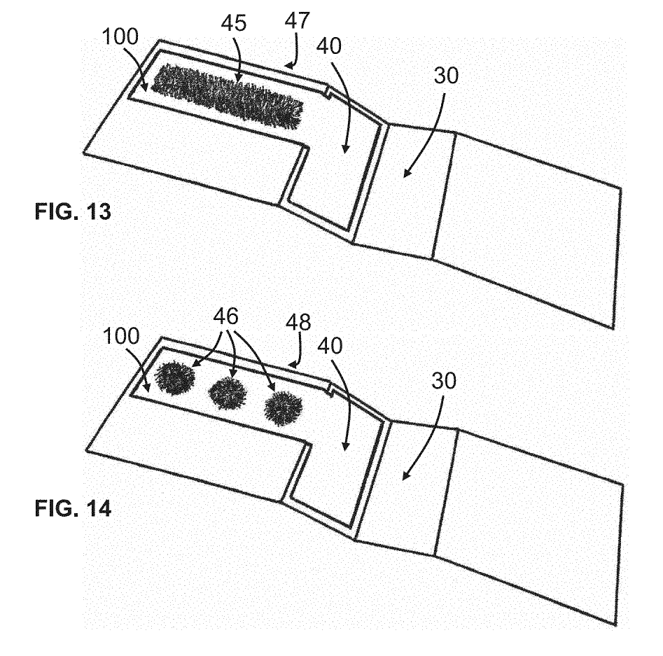

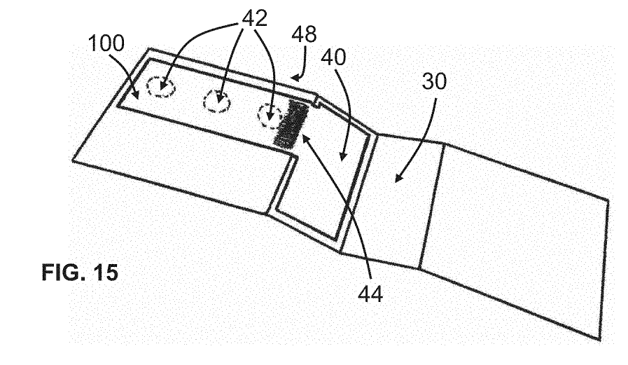

FIGS. 13 and 14 show unfolded label 30 and steep timer label flap 32 with attached steep timer 40 with rectangular steep timer segment 100. Sleep timer 40 may be a laminar material that has the property of being translucent when wetted. FIG. 13 shows rectangular shaped color segment 45 printed on top of steep timer 40 that accommodates continuous steep timer indicator 47 under steep timer 40. FIG. 14 exemplifies three individual colored segments 46 printed on top of steep timer 40 that accommodates individual steep time indicators 48 under steep timer 40. Such print on the backside of steep timer 40 may be simply accomplished with generic printing or painting color on to paper. Once steep timer 40 is wet by the capillary action of the fluid, it becomes translucent allowing the steep timer indicator to display the colored segments that are printed on the backside of the steep timer segments. Instead of a printed or painted color segment, another embodiment uses colored food power that combines with the fluid traveling in steep timer 40, providing to visual indications of the steep timer indicator. Using colored food powder is preferred to provide food-save conditions, especially when used in combination with food or if there is a possibility that the label could be accidentally inserted into the beverage.

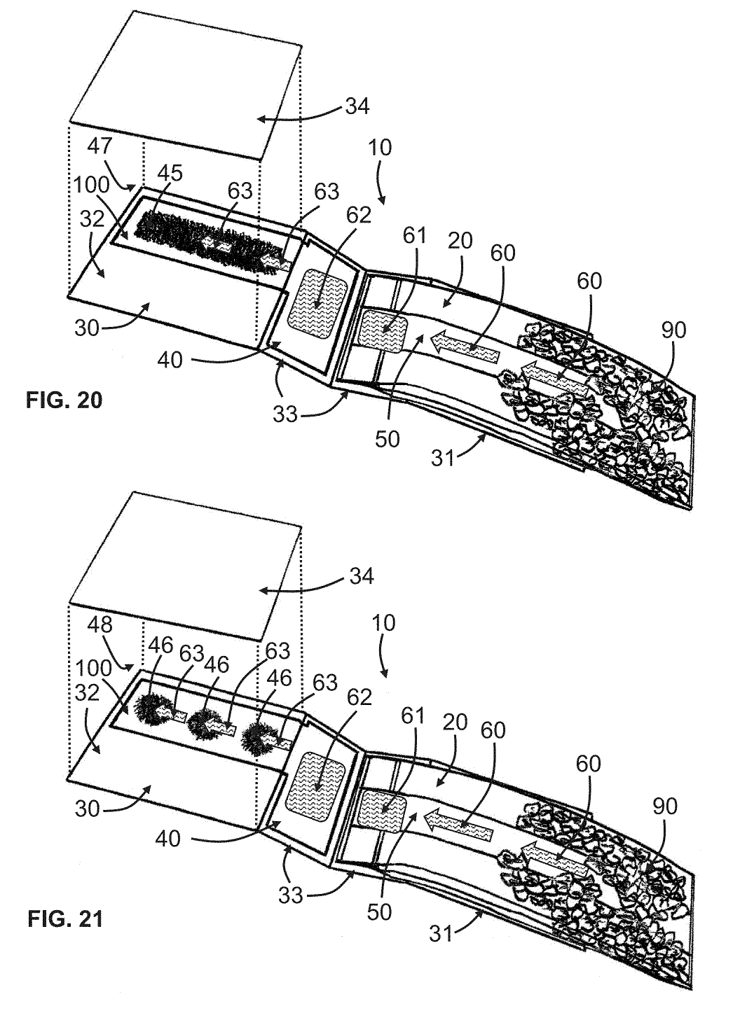

FIG. 15 illustrates another embodiment of visual color indication of the steep timer indicator of the inventive apparatus. It shows unfolded label 30 with attached steep timer 40 with rectangular steep timer segment 100. Color segment 44 is placed adjacent to individual steep time indicators 48 under steep timer 40 rather than on top. Fluid traveling along steep timer 40 first combines with color segment 44, for example made from food coloring powder. The then colored fluid travels along steep timer 40 and functions as a coloring indicator. The function of such steep timer, the steep time indicators and the movement of fluids inside the various embodiments of the inventive apparatus will become clearer in the following illustrations FIGS. 20 through 22.

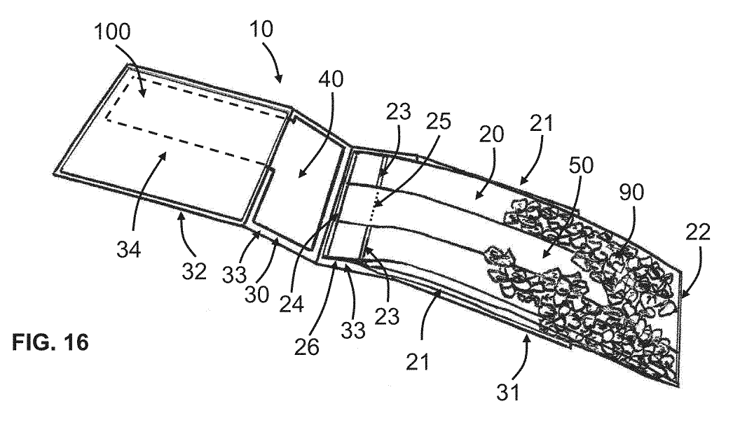

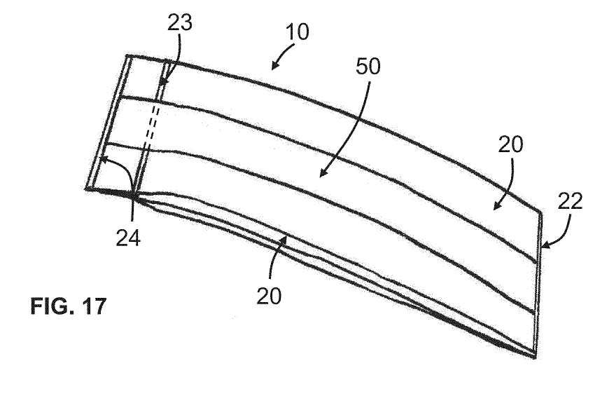

FIG. 16 shows the teabag with steep timer apparatus 10 in an unfolded stage. Teabag 20 is attached to label 30, and more specifically to the inside of label handle 33 that is connected to front label flap 31. Teabag 20 contains tea leaves 90 and transport fluid device 50. In one embodiment, teabag 20 is made from nylon material, with the bottom end cut and sealed via an ultrasonic nylon welding method creating bottom seal 22. Top seals 23 made with an ultrasonic nylon welding method are placed at the top of teabag 20 with seal gap 25 in order not to hinder the fluid transport in fluid transport strip 50. The top of teabag 20 is sealed with top end seal 24 via an ultrasonic nylon welding method. Top seals 23 help to keep fluid transport device 50 in place and prevent tea leaves 90 from entering teabag attachment area 26 between top seals 23 and top end seal 24 to allow proper attachment of teabag 20 to the backside of label handle 33. In this embodiment, teabag 20 has double-folded teabag sides 21 to add stability to the teabag allowing for easier insertion into a disposable beverage cup through the opening positioned in a disposable lid. FIG. 16 also shows steep timer 40 attached to the back of label handle 33 on steep timer label flap 32 side of label 30. For fluid protection and to support the integrity of the steep timer, steep timer flap cover 34 is attached on top of the steep timer segment, such as steep timer segment 100. Steep timer flap cover 34 is made, in one exemplary embodiment, from paper or cardboard paper with additional bonding to increase water resistance. However, other materials, such as plastic or an adhesive tape may be used as well.

In another embodiment, other teabag sealing methods, such as gluing or using adhesive strips, may be used to help maintain tea leaves 90 inside teabag 20 and out of teabag attachment area 26. In another embodiment, multiple seals may be placed onto the teabag to seal it and restrict the dispersion of tea leaves 90 in a certain area of teabag 20. In a further embodiment, teabag side 21 may be made of a simple or multiple folds.

FIG. 17 shows another embodiment of teabag 20 of steep timer apparatus 10 and transport fluid device 50. Here, transport fluid device 50 is attached to the outside of teabag 20. If fluid transport device 50 is attached to the outside of teabag 20 and not arranged inside of it, top seal 23 is optionally extended to the entire width of the teabag. Teabag 20 with an outside attached transport fluid device 50 contains top end seal 24 and bottom seal 22. The attachment of transport fluid device 50 to the outside of teabag 20 may be accomplished with glue or other attaching mechanisms.

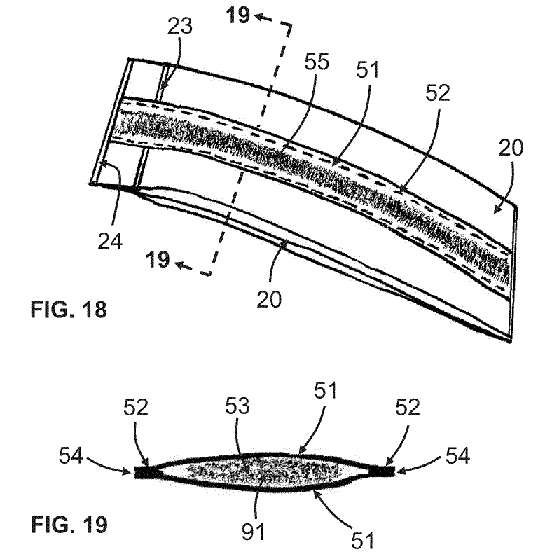

FIG. 18 illustrates another embodiment of fluid transport device 55. FIG. 19 provides a cross section view along section lines 1-1 of this embodiment. Here, fluid transport device 55 is constructed from two or multiple filter layers 51 that are attached at fluid transport device ends 52, for example with glue 54. These create cavity 53 that contains tea powder 91 or similar ingredients that enhance aroma and color of the beverage. In general, premium tea leaves and ingredients are made from a rough cut of tea and ingredients with a smaller surface area. The premium tea leaves and ingredients provide consumers with the view and touch of premium tea, however it provides a lesser amount of the color and aroma to the beverage. Tea powder on the other hand is a fine cut of tea leaves. It is considered of less quality and is less expensive as it is more difficult to filter and often leaves tea ingredients in the beverage. It this embodiment, fluid transport device 55 not only allows fluid to travel to the steep timer, but it also functions as a coloring and aroma enhancer. In another embodiment, fluid transport device 55 is constructed with multiple layers of filter layers 51 and with multiple cavity 53 areas.

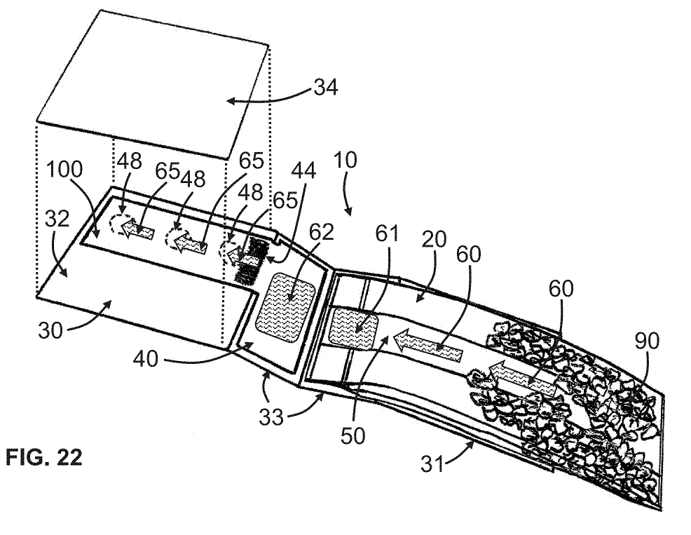

FIGS. 20 through 22 describe the movement of the fluid along fluid transport device 50 and steep timer 40. It is illustrated with teabag 20 and steep timer apparatus 10 in an unfolded stage. Teabag 20 is attached to label 30, and more specifically to the inside of label handle 33 that is connected to front label flap 31. Teabag 20 contains tea leaves 90 and transport fluid device 50. Steep timer 40 is attached to steep timer label flap 32 and label handle 33 with rectangular steep timer segment 100. FIG. 20 has rectangular shaped color segment 45. FIG. 21 exemplifies three individual colored segments 46. FIG. 22 shows color segment 44, for example made from food coloring powder, located adjacent to individual steep time indicators 48 under steep timer 40. Steep timer flap cover 34 is removed in FIGS. 20 through 22 for better illustration.

Once teabag 20 is entered into a fluid, the fluid traverse fluid transport device 50 due to the capillary action or wicking effect. FIGS. 20 and 22 illustrate the initial movement of fluid 60 alongside fluid transport device 50. Once the fluid travels to the top of fluid transport device 50, it reaches fluid transport transfer section 61 on fluid transport device 50. For better illustration, FIGS. 20 through 22 show the teabag with steep timer apparatus 10 in an unfolded stage. When in a folded stage, fluid transport transfer section 61 is adjacent to steep timer fluid transport section 62. If transport fluid device 50 is placed inside teabag 20, one layer of nylon, or other teabag material, is located between fluid transport transfer section 61 and steep timer fluid transport section 62. If transport fluid device 50 is attached to the outside teabag 20, fluid transport transfer section 61 and steep timer fluid transport section 62 are contacting. Tests have shown that the fluid transfer between fluid transport transfer section 61 and steep timer fluid transport section 62 is slightly faster compared to when one or more layers of nylon, or other teabag material is located between them.

FIG. 20 shows the fluid traveling from steep timer fluid transport section 62 onto rectangular steep timer segment 100, shown as steep timer fluid movement 63. The fluid combines with rectangular shaped color segment 45. Once the steep timer becomes wet, it becomes translucent and the colors are visible as color indicators through continuous steep timer indicator 47. FIG. 21 also shows the fluid travelling from steep timer fluid transport section 62 onto rectangular steep timer segment 100, shown as steep timer fluid movement 63. Here, the fluid will combine with three individual colored segments 46 that accommodate individual steep time indicators 48. Once wet, the steep timer becomes translucent through which the colors are visible as indicators.

FIG. 22 shows the fluid transfer when using adjacent located color segment 44, for example made from food coloring powder. Here also, with the initial movement of fluid 60, the fluid is moving up fluid transport device 50 to fluid transport transfer section 61. In the folded stage, fluid transport transfer section 61 is adjacent and will transfer the fluid to steep timer fluid transport section 62. From steep timer fluid transport section 62 the fluid will combine with the food coloring powder in color segment 44 and create colored fluid movement 65. Colored fluid movement 65 transports the color further along the here shown rectangular steep timer segment 100 to individual steep timer indicator 48 under steep timer 40. Colored fluid movement 65 colors steep timer 40 that is visible as individual steep time indicators 48.

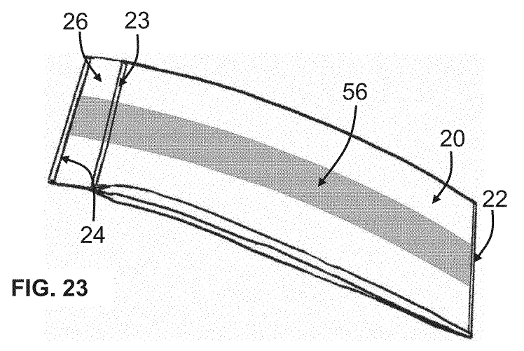

FIG. 23 shows another embodiment of teabag 20. Here, the fluid transport mechanism is accomplished with materials with capillary action capabilities, such as cotton fibers, paper fibers or similar, weaved into or onto the teabag material, such as nylon or silk, to create integrated fluid transport device 56. When using integrated fluid transport device 56, top seal 23 may be optionally extended to the entire width of teabag 20. As discussed prior and not shown here, this prevents tea leaves from entering teabag attachment area 26 between top seals 23 and top end seal 24, allowing proper attachment of teabag 20 to label 30 (not shown here). The teabag with integrated fluid transport device 56 also contains bottom seal 22.

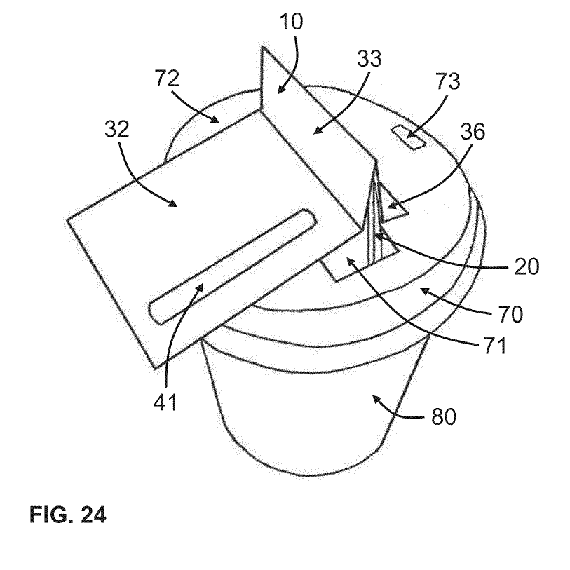

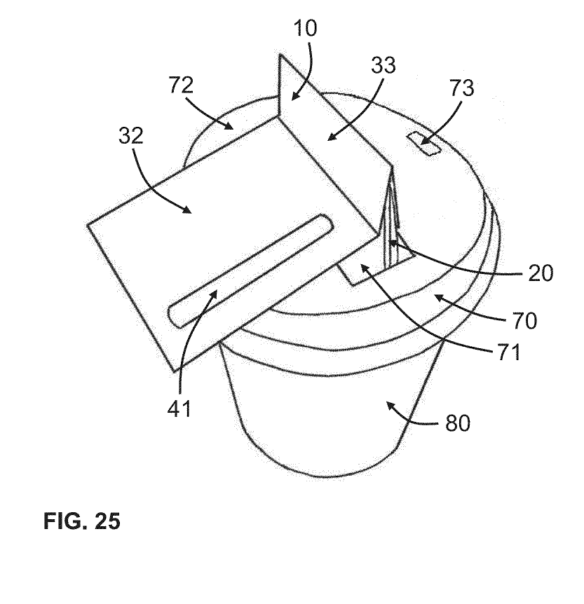

FIGS. 24 and 25 show other embodiments of teabag 20 and steep timer apparatus 10 consisting of label 30 and attached teabag 20. Teabag 20 is inserted in disposable beverage cup 80 through disposable lid 70 via lid opening 71 of lid surface 72. FIG. 24 shows label 30 consisting of short front label flap 36, steep timer label flap 32, and label handle 33. Short front label flap 36, allows the consumer to consume the beverage through drink opening 73 even with teabag 20 and steep timer apparatus 10 inserted in disposable beverage cup 80 through disposable lid 70. FIG. 25 is similar of FIG. 24, but with front label of label 30 completely removed. Additional embodiments include any size and shape of the front label flap 36.

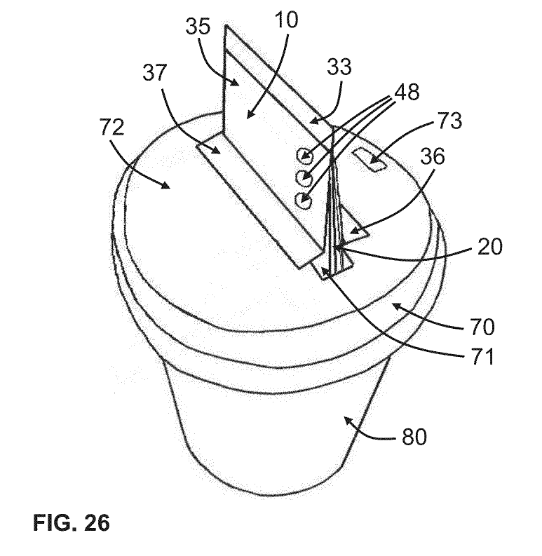

FIGS. 26 through 31 show another embodiment of teabag 20 and steep timer apparatus 10. Here, the steep timer mechanism is integrated in label handle 33 creating upright steep timer apparatus 35. In FIG. 26 upright steep timer apparatus 35 contains individual steep time indicators 48. A further embodiment would entail a continuous steep timer indicator, as introduced in FIG. 5 or an ornamental steep time indicator, as shown in FIG. 6.

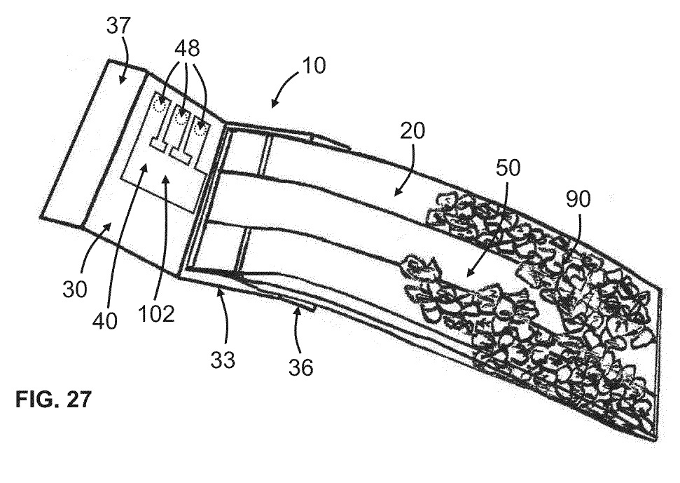

For better illustration, FIGS. 27 through 29 show teabag 20 steep timer apparatus 10 with upright steep timer apparatus 35, in an unfolded stage and with upright steep timer back cover 160 removed. Teabag 20 is attached to label 30, and more specifically to the inside of label handle 33 that is connected to front label flap 36. Teabag 20 contains tea leaves 90 and transport fluid device 50. Steep timer 40 is attached to label 30, and more specifically to the inside of label handle 33 that is connected to back label flap 37. For illustration purposes in FIGS. 27 through 30, steep timer 40 is shown with pathway shaped steep timer segments 102, and with individual steep time indicators 48 under steep timer 40. Other shapes of the steep timer segments and other steep time indicators, such as continuous steep timer indicator 47 as shown prior in FIG. 5 and ornamental steep time indicator 49 as shown in FIG. 6 provide other embodiments.

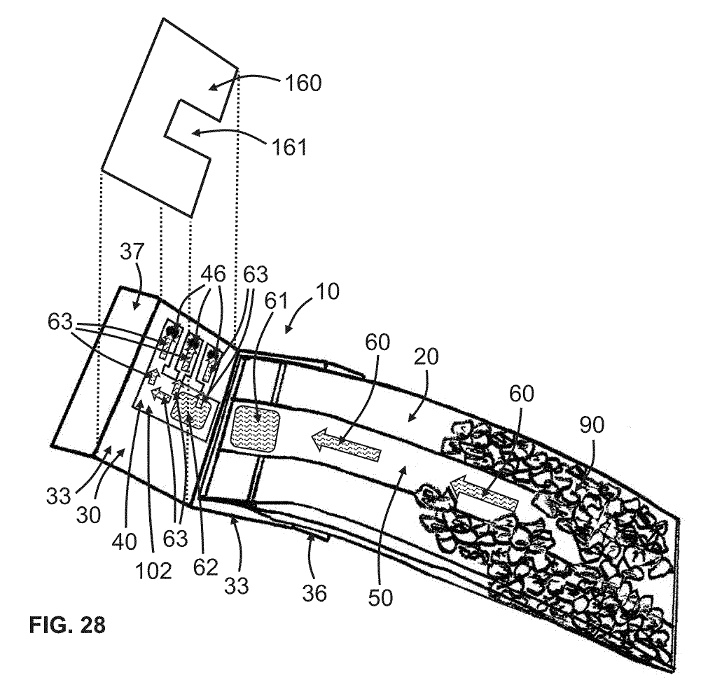

FIGS. 28 through 30 describe the movement of the fluid along fluid transport device 50 and steep timer 40 in a teabag with steep timer apparatus 10 with upright steep timer apparatus 35. Once teabag 20 is entered into a fluid, the fluid traverses alongside fluid transport device 50 due to the capillary action or wicking effect and reaches transport transfer section 61. When in folded stage, fluid transport transfer section 61 is located adjacent to steep timer fluid transport section 62, which allows for fluid transfer. As discussed earlier, one or more layer of teabag material may be located between fluid transport transfer section 61 and steep timer fluid transport section 62 without significantly reducing the fluid transfer capabilities. To allow the fluid transfer from fluid transport transfer section 61 to steep timer fluid transport section 62, upright steep timer back cover 160 requires back cover cutout 161.

FIG. 28 shows the fluid traveling as steep timer fluid movement 63 from steep timer fluid transport section 62 onto pathway shaped steep timer segments 102 to three individual colored segments 46 that accommodate individual steep time indicators 48.

The fluid combines with individual colored segments 46. Once the steep timer become wet, it becomes translucent and the colors are visible as color indicators.

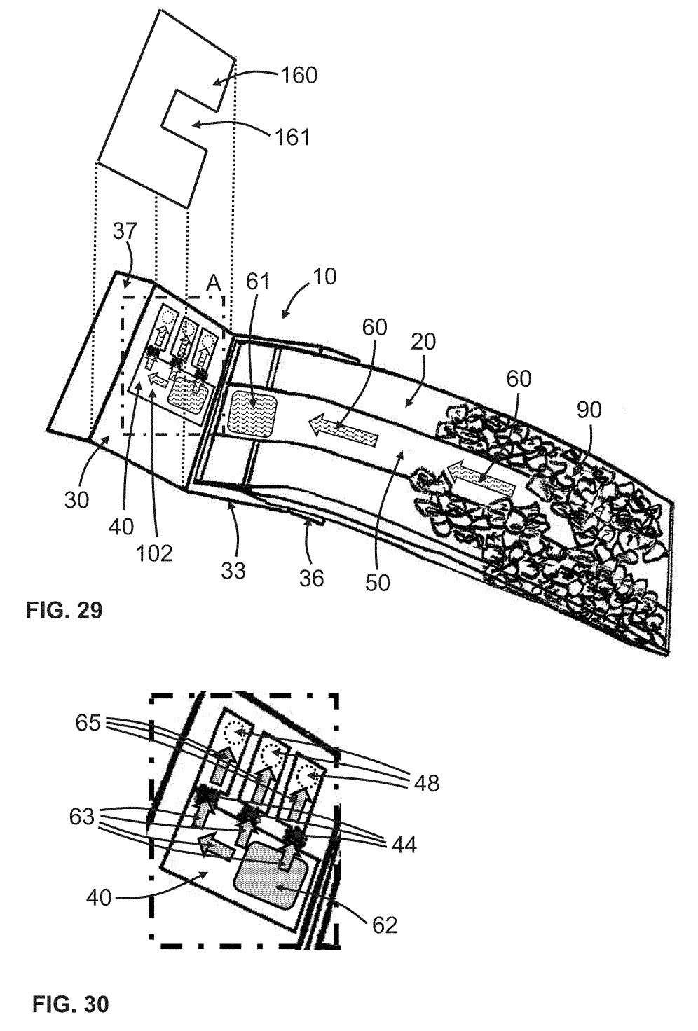

FIG. 29 shows the fluid transfer in a teabag with steep timer apparatus 10 with upright steep timer apparatus 35 when using adjacent located color segment 44. Adjacent located color segment 44 is optionally made from food coloring powder and are adjacent to individual steep time indicators 48.

FIG. 30 provides an enlarged view of section A of FIG. 29. It shows the fluid traveling, as shown as steep timer fluid movements 63, from steep timer fluid transport section 62 to the food coloring powder in color segments 44. Then, the combined food coloring powder in color segments 44 and fluid in steep timer fluid movements 63 create colored fluid movements 65. These colored fluid movements 65 color steep timer 40 which becomes visible once wet as individual steep time indicators 48.

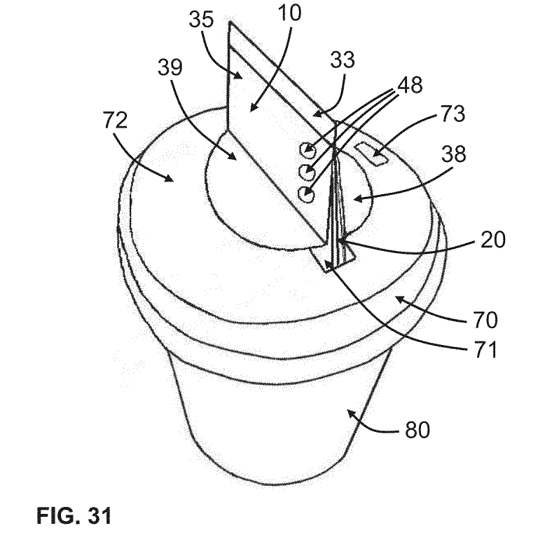

FIG. 31 shows teabag 20 and steep timer apparatus 10 with upright steep timer apparatus 35 similar to FIG. 26, but with circular front label flap 38 and circular back label 39. Other embodiments of teabag 20 and steep timer apparatus 10 and upright steep timer apparatus 35 contain any other size and shape of a front label flap and a back label flap. Other embodiments of teabag 20 and steep timer apparatus 10 and upright steep timer apparatus 35 contain a single or no front and no back flaps.

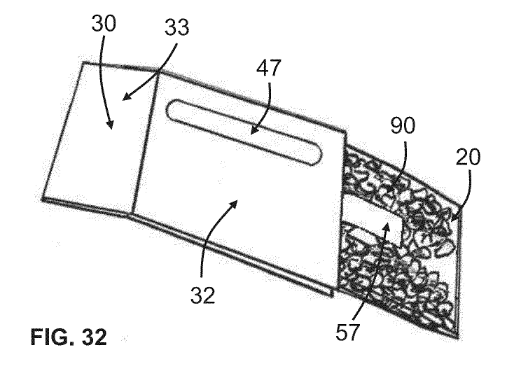

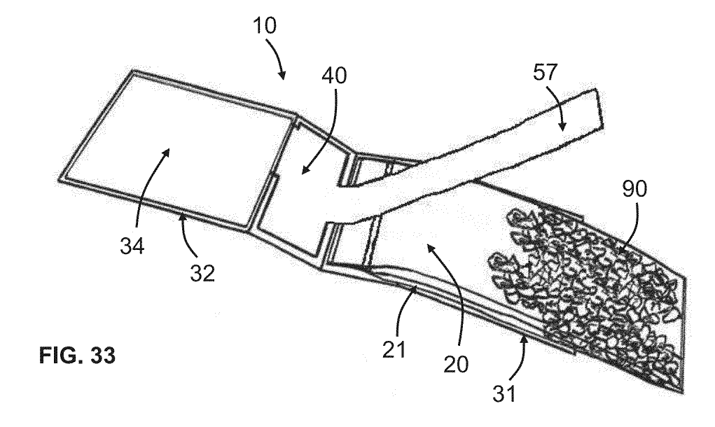

FIGS. 32 and 33 show a further embodiment of teabag 20 and steep timer apparatus 10. Here loose fluid transport device 57 is not connected, inserted or attached to teabag 20. FIG. 32 shows this embodiment in a folded state and FIG. 33 in an unfolded stage. FIG. 33 shows loose fluid transport device 57 being attached to steep timer 40. The consumer of a beverage using this embodiment of the apparatus of the present invention may decide to either measure or not to measure the steep time by either inserting loose fluid transport device 57 into the beverage or leave it outside. If the consumer desires to measure the steep time, loose fluid transport device 57 is inserted with teabag 20 into the fluid. The fluid will travel up loose fluid transport device 57 to steep timer 40, which then transports the fluid to the steep time indicators as described earlier.

In another embodiment, loose fluid transport device 57 may also be used in steep timer apparatus 10 in combination with upright steep timer apparatus 35 as introduced earlier in FIGS. 26 through 31.

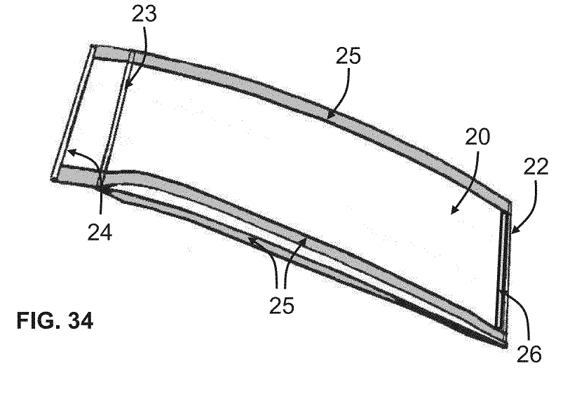

FIG. 34 shows another embodiment of teabag 20, with teabag side stiffener 25 and teabag bottom stiffener 26. These stiffeners are made typically from paper or cardboard with additional water resistant bonding. In a further embodiment, other materials, such as plastic may be used. Teabag stiffeners support teabag stability for insertion of the teabag with steep timer apparatus in disposable beverage cup 80 through disposable lid 70 as shown earlier in FIGS. 1 and 2.

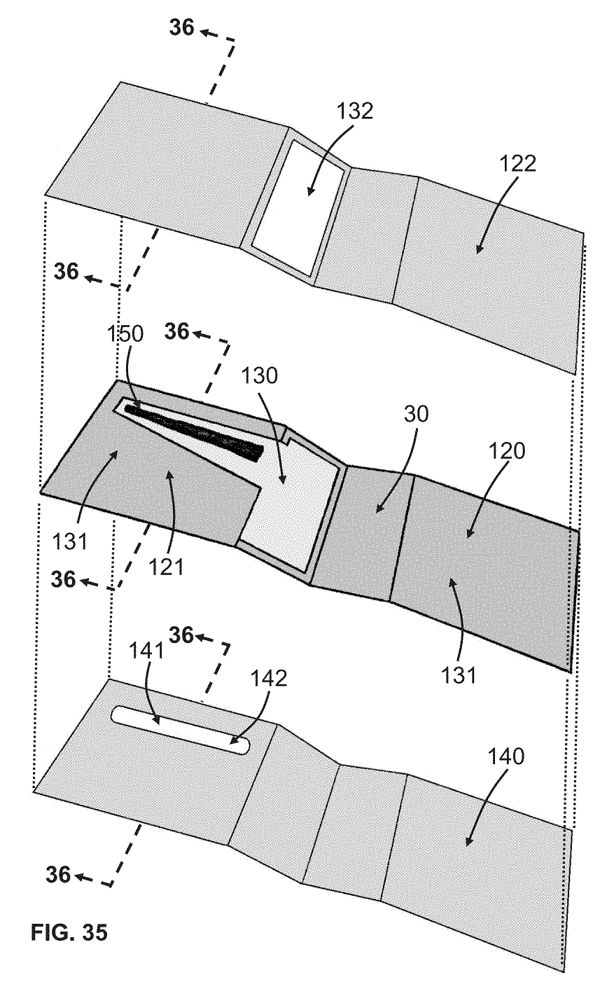

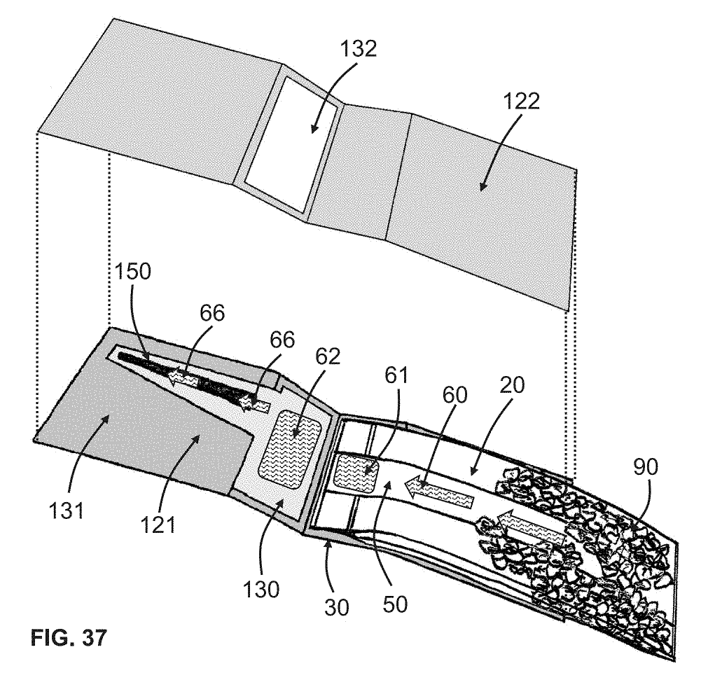

FIGS. 35 through 37 show another embodiment of the label with steep timer. Here, label 30 is integrated steep timer 120 that is constructed of one or multiple materials, such as different filter papers or different chromatography papers, with different capillary actions and capabilities. These differences are used to set the steep time indicator at the selected desired activation times. FIG. 35 shows an integrated steep timer 120 made of two paper filter materials 130 and 131 and color segment 150, either a color print or preferably made from food coloring powder. Paper filter material 130 is a paper with good capillary action, and paper filter material 131 is paper with zero or nearly no capillary action. Inside paper bonding 122 is shown separated from the integrated steep timer 120 for ease of illustration. Paper bonding 122 provides sufficient water resistant to prevent soaking once filter materials 130 and 131 become wet during steeping, but does not extend to label section cutout 132. Label section cutout 132 is necessary to allow for required fluid transfer, which is further described in FIG. 37.

Water resistant bonding laminate 140 is also shown separated from integrated steep timer 120 for ease of illustration. Water resistant bonding laminate 140 is used for graphics, color design and text, but leaves translucent viewing window 141 to function as continuous steep time indicator 142. In another embodiment of integrated steep timer 120, numerous other materials with different thicknesses and shapes are used to accomplish the desired capillary action and associated step timer indications.

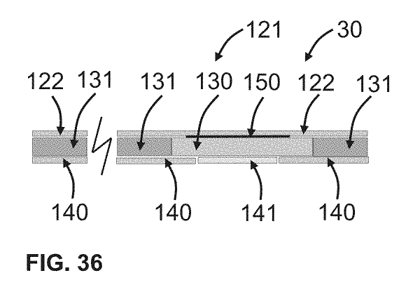

FIG. 36 shows a cross section view of steep timer label flap 121 of label 30 taken on section lines 2-2. It shows the two paper materials two paper filter materials 130 and 131, color segment 150, inside paper bonding 122, and water resistant bonding laminate 140.

FIG. 37 shows initial movement of fluid 60 alongside fluid transport device 50. For this illustration the teabag with steep timer apparatus 10 is shown in an unfolded stage and with inside paper bonding 122 shown separated from integrated steep timer 120. Once the fluid travels to the top of fluid transport device 50, it reaches fluid transport transfer section 61 on fluid transport device 50. In the folded stage, fluid transport transfer section 61 is adjacent and will transfer the fluid to steep timer fluid transport section 62. From steep timer fluid transport section 62 the fluid continues with fluid movement 66 in filter paper material 130 with good capillary action. The integrated steep timer presents a lower cost alternative to provide a label with steep timer. Another embodiment for teabag 20 and steep timer apparatus 10 and integrated steep timer 120 includes the use of loose fluid transport device 56 or the application within upright steep timer apparatus 35 similar to FIG. 26.

The present invention having been thus described with particular reference to the preferred forms thereof, it will be obvious that various changes and modifications may be made therein without departing from the sprit and scope of the present invention as defined in the appended claims.

What is claimed is:

1. An apparatus for preparing a beverage, the beverage ingredients having a desired steep time, comprising:
a liquid immersible bag, said bag structured and arranged to hold the ingredients of the beverage, the bag structured and arranged to be immersed in liquid such that the ingredients of the beverage may steep in the liquid when immersed;
a capillary action fluid transport device associated with the liquid immersible bag; and
at least one flap carrying a steep timer device with at least one visual indicator of the expiration of a predetermined steeping time, said steep timer device being constructed with a wicking media, said wicking media being in contact with said capillary action fluid transport device.

2. The apparatus of claim 1, wherein said liquid immersible bag has at least one side fold, wherein said side fold acts as a stiffener to facilitate insertion through an opening of a lid of a cup.

3. The apparatus of claim 1, wherein said liquid immersible bag has rigid sides, wherein said rigid sides act as stiffeners to facilitate insertion through the opening of a lid of a cup.

4. The apparatus of claim 3, wherein said rigid sides comprise one of cardboard and plastic.

5. The apparatus of claim 1, wherein said wicking media is one of chromatography paper and filter paper.

6. The apparatus of claim 1, wherein said visual indicator has at least one continuous progress steep time indicator.

7. The apparatus of claim 1, wherein said visual indicator has at least one ornamental design steep time indicator.

8. The apparatus of claim 1, wherein said capillary fluid transport device is attached to the outside of the liquid immersible bag.

9. The apparatus of claim 1, wherein said capillary fluid transport device includes material with capillary action that is integrated into the material of the liquid immersible bag.

10. The apparatus of claim 1, wherein said capillary fluid transport device includes at least one cavity, said cavity adapted to carrying additional beverage ingredients or supplements.

11. The apparatus of claim 1, wherein said wicking media of said flap is comprised of two or more integrated materials with different capillary action characteristics.

12. An apparatus for preparing a beverage having a desired steep time, comprising:
beverage ingredients;
a liquid immersible bag, said bag holding the beverage ingredient, said bag having an associated capillary fluid transport device; and
a steep timer device with visual indicator of the expiration of a predetermined steep time, said visual indicator including a wicking media; and
a handle, said bag being attached to said steep timer at said apparatus handle.

13. The apparatus of claim 12, wherein said liquid immersible bag has at least one side fold, said side fold acting as stiffener to facilitate insertion through an opening of a lid of a cup.

14. The apparatus of claim 12, wherein said liquid immersible bag has rigid sides, said rigid sides acting as stiffeners to facilitate insertion through an opening of a lid of a cup.

15. The apparatus of claim 14, wherein said rigid sides includes one of cardboard and plastic.

16. The apparatus of claim 12, wherein said visual indicator has at least one continuous progress steep time indicator.

17. The apparatus of claim 12, wherein said visual indicator has at least one ornamental design steep time indicator.

18. The apparatus of claim 12, wherein said capillary fluid transport device is attached to the outside of said liquid immersible bag.

19. The apparatus of claim 12, wherein said capillary fluid transport device has material with capillary action integrated into the material of said liquid immersible bag.

20. The apparatus of claim 12, wherein said capillary fluid transport device includes at least one cavity, said cavity carrying additional beverage ingredients or supplements.

21. The apparatus of claim 12, wherein said wicking media is one of chromatography paper and filter paper.

22. The apparatus of claim 12, wherein said upright steep timer device is comprised of two or more integrated materials with different capillary action characteristics.
